(19) United States
(12) Patent Application Publication
(10) Pub. No.: US 2014/0164065 A1
(43) Pub. Date: Jun. 12, 2014

(54) Strategic Business Objectives Based Program Management Systems and Methods

(71) Applicant: FLUOR TECHNOLOGIES CORPORATION, Aliso Viejo, CA (US)

(72) Inventor: Robert Prieto, Princeton Junction, NJ (US)

(73) Assignee: FLUOR TECHNOLOGIES CORPORATION, Aliso Viejo, CA (US)

(21) Appl. No.: 13/709,996

(22) Filed: Dec. 10, 2012

(51) Int. Cl. G06Q 10/06

(52) U.S. Cl. CPC G06Q 10/0637
USPC 705/7.36

(57) ABSTRACT

Systems and methods are presented for program management based on strategic business objectives (SBO) of an organization. One aspect of the inventive subject matter includes a method of tracking SBOs of a program including providing access to a SBO database that stores SBO objects, which are representative of the SBO's. The method further includes providing access to an SBO analysis engine coupled with the SBO database. The SBO analysis engine can be configured to identify one or more stakeholders responsible for achieving or assessing an objective associated with one or more SBO objects and retrieve SBO perception attributes from the stakeholders for the one or more SBO objects. The method can further include deriving a SBO perception drift for the SBO object as a function of the stakeholder's SBO perception attributes and the SBO attributes of the SBO object and presenting the SBO perception drift on an output device.

### FIELD OF THE INVENTION

The field of the invention is program management technologies.

### BACKGROUND

Private and public entities are increasingly undertaking large scale and complex programs utilizing a program management approach. Such programs typically encompass numerous projects and often span across decades, making them not only crucial for the organizations that undertake such programs but also impacting the overall strategic business objectives of the organizations. The growing scale, complexity and durations of these programs require the use of a comprehensive yet integrated management system incorporating features, techniques, work processes, and tools that are able to showcase all program management parameters. Most existing project management tools focus on scheduling or allocating resources for various activities and periodically assessing progress of concerned projects to take necessary measures when the progress is not as expected. However, large, complex, and long term programs need to deal with much wider, high-level, or organization impacting issues other than scheduling and assessment of resources.

Key features typically required in the management of these large programs include identifying, assessing, modeling, analyzing, forecasting, tracking, managing and reporting on a wide range of outcomes, outputs, processes, constraints and drivers. Existing management systems do not cater to aspects relating to strategic business objective tracking, governance assessment, or strategy phase activities and are typically confined to project level activities and assessment of short term parameters rather than mapping or monitoring of long term operations, objectives, maintenance or stakeholder aspirations.

Features of existing project management systems that are often employed in a program management context currently lack the owner's broader and more strategic perspective, which is a key differentiator between projects and programs. Tools currently employed in program risk assessment are limited to static risk assessments typically using Monte Carlo techniques and do not employ a comprehensive approach for opportunity identification. As programs typically deal with high-level strategic business objectives being met, evaluation and assessment of the program from an owner's perspective and from perspectives of other stakeholders becomes crucial in assessing the long term success of the concerned program. Differences in perspectives of owners and other stakeholders can lead to failures in the programs and can even impact the organization at large. It is therefore crucial to determine the strategic business objectives (SBO's) for each program and then periodically identify or assess the magnitude of difference in perspectives of various stakeholders, identify the SBO's for which the perspectives vary, reasons for the difference in perspectives, projects or activities responsible for the difference, among other like attributes. This is even more crucial in large and complex programs in which small to medium term projects may change the perception of strategic business objectives of the stakeholders over a period of time.

U.S. Patent Application No. 2008/0281651 to Brennan et al. titled “Method and System for Managing a Strategic Plan via Defining and Aligning Strategic Plan Elements”, filed on May 10, 2007, discusses development and alignment of strategy elements including required business outcomes (RBO's), strategic business outcomes (SBO's), and desired business outcomes (DBO's), wherein RBO's are assigned to key result areas (KRA's). Brennan basically discloses development and storage of multiple business outcomes and association of KRA's with each business outcome and tracking of the business outcomes using the KRA's but does not cater change in perception of the business outcomes in the concerned stakeholders making the problem of aligning the stakeholders to existing or changing strategic business outcomes unsolved.

U.S. Patent Application No. 2005/0216324 to Maithell et al. titled “System and Method for Constructing a Schedule that Better Achieves one or more Business Goals”, filed on Feb. 9, 2005, discusses constructing a schedule that better achieves one or more business goals by generating a schedule optimized for reaching a business objective or business constraint. The disclosure therefore mentions about optimized scheduling of costs and other resources and fails to disclose any subject matter relating to measurement of the extent of alignment between owners perception of the business objective and of another stakeholder.

U.S. Pat. No. 8,005,709 to King et al. titled “Continuous Audit Process Control Objectives”, filed on Jun. 17, 2003, discusses monitoring a business process and incorporating an indicator for determining a value representing performance of business process. The disclosure also discusses about incorporating a performance monitor adapted to evaluate the indicator to determined performance of business process, wherein the monitor compared the value of the indicator with a target value and makes a report based on the comparison.

Thus, there is still a need for a program management system and method that can assess the drift in perception of strategic business objectives in view of one or more stakeholders and evaluate the extent of drift or reasons for the drift so as to propose measures that can be taken to reduce or remove the drift.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

### SUMMARY OF THE INVENTION

The inventive subject matter provides systems and methods for program management based on strategic business objectives (SBO) of an organization or of a program where SBO's can include fundamental or high level outcomes to be achieved through implementation of the program or by the organization such as return on capital employed (ROCE), return on investment, market share, percentage of market need satisfied, targeted growth rates, among other such objectives. One aspect of the inventive subject matter includes a method of tracking strategic business objectives (SBO) of a program including providing access to a SBO database that stores SBO objects, which are representative of the SBO's and can include program level objectives or organization level objectives that are desired to be achieved. It has been appreciated that a program can include multiple projects and can span across five years, a decade, or even a century, and therefore the complexity in terms of execution, projection, assessment, or allocation for a program is significantly higher when compared to project level metrics. Program level SBO objects can represent objectives such as total time to completion, overall costs till completion of the program, scope to be achieved, among other such objectives. Organizational level SBO objects, on the other hand, can relate to mission or vision statements of the organization and can include return on investment, market share to be captured, revenue to be earned, profit margin, number of standards to which the organization has to comply, number of physical resources, number of offices, number of clients, among other such objectives.

Each SBO object can have one or more attributes that define the respective SBO object and can help quantitatively or qualitatively assess whether the objective to which the object relates has been achieved or not, apart from also helping understand other characteristics of the SBO object. In an embodiment, key performance indicators (KPI) can be defined as attributes for each object and measured periodically to assess whether they, individually or collectively, are aligned to meet the desired objective. For example, assuming that the “total cost till completion” of a 50 year duration program has been identified as a program objective and is budgeted to be USD 500 million, an SBO object for the objective can be the total cost of the program, which can be measured through one or more attributes such as “number of resources being used” and “cost of each such resource”. Such attributes can be measured, say every 6 months, to assess whether the desired total cost of USD 500 million for the program is in line.

The method further includes providing access to an SBO analysis engine that is operatively coupled with the SBO database. The SBO analysis engine can be configured to identify one or more stakeholders responsible for achieving or assessing an objective associated with one or more SBO objects and retrieve SBO perception attributes from the stakeholders for the one or more SBO objects. Stakeholders not only include owners or key people internal to the organization but can include external stakeholders such as investors, bond holders, regulatory authorities, legislature, among other such entities that are directly or indirectly associated with meeting of the SBO objects or are impacted directly or indirectly by efforts to achieve an SBO. Perception attributes received from the stakeholders can be stored in the SBO database and can correspond to the same or a partial set of SBO attributes responsible for the concerned SBO objects. The SBO perception attributes can be configured to reflect the perception of the concerned stakeholder about the SBO object to which the attributes relate and can vary for each stakeholder as they reflect their personal opinion about the performance of the SBO attributes, such as KPI's, at periodic intervals.

The method can further include deriving SBO perception drift for the SBO object as a function of the stakeholder's SBO perception attributes and the SBO attributes of the SBO object. Deviation or magnitude of difference, which is representative of the SBO perception drift, can initially be computed between each SBO perception attribute and corresponding SBO attribute of the SBO object and then the deviation for all SBO attributes can be cumulated to compute the SBO perception drift of the SBO object. The method can further include configuring and presenting the SBO perception drift on an output device. Magnitude of drift can indicate the level of change in perception of the concerned stakeholder with respect to the desired perception of the SBO, and can help the management or other stakeholders assess the reasons behind the drift and take suitable actions to ensure that each stakeholder is aligned with current or modified SBO's.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a program management system comprising a SBO database and an SBO analysis engine coupled via a network.

FIG. 2 is a schematic block diagram of the program management system.

FIG. 3 is an example method of program management.

### DETAILED DESCRIPTION

It should be noted that while the following description is drawn to program management systems and methods, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including generating signals representative of stakeholder's perception drift of objects relating to strategic business objectives (SBO) and configuring output devices to present the perception drift. The signals can include one or more packets of input data used for running the simulations and output data received from the simulation that are conveyed over a network (e.g., the Internet, cell phone network, etc.) and received by an electronic device operating as the output device. In response, the electronic device configures itself according to the signal to present the perception drift information.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The following discussion describes the inventive subject matter with respect to various numbers of records relating to SBO objects, SBO attributes, SBO perception attributes, or SBO perception drift, stored in databases. One skilled in the art will recognize that the inventive subject matter can scale as necessary to any number of items without departing from the inventive subject matter.

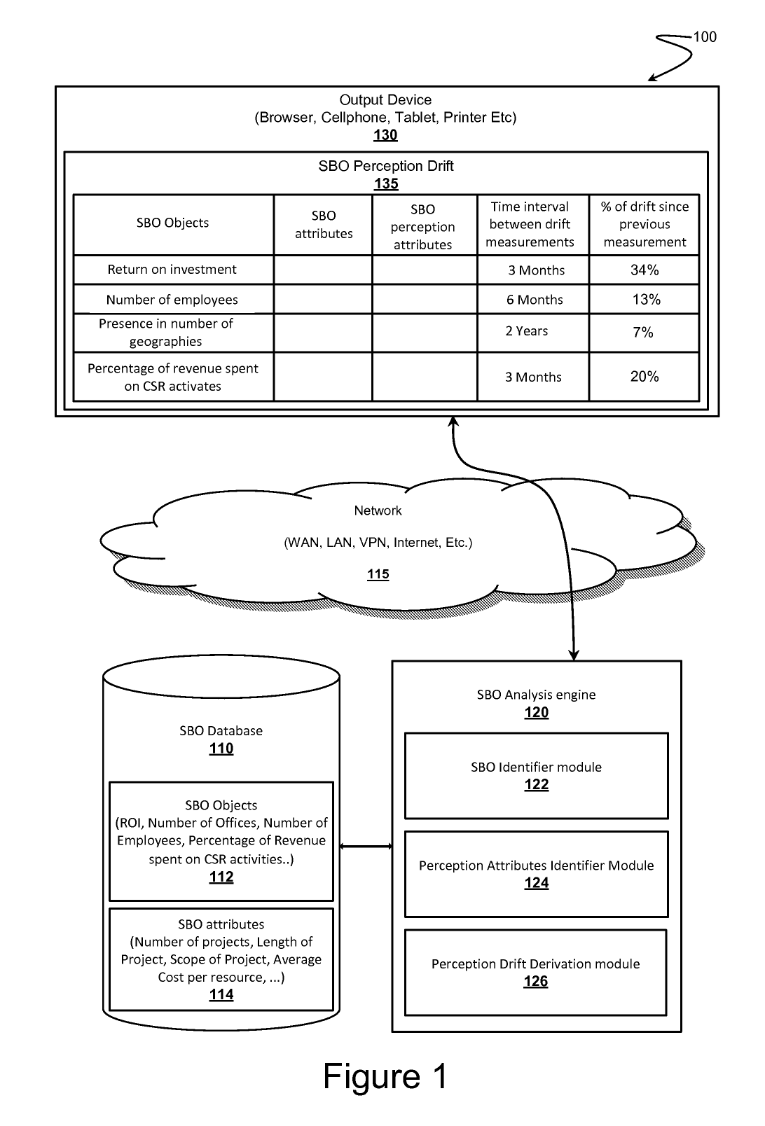

FIG. 1 is a schematic of a program management system 100 comprising a SBO database 110 and an SBO analysis engine 120 coupled via a network. Program management system 100 of the present disclosure can include assessment of degree of alignment of various stakeholders with respect to strategic business objectives (SBO) of the program or of the organization, or a combination of both. Strategic business objectives typically relate to long term objectives that organizations define and intend to achieve so as to enable success of their vision or mission statements. Such objectives can relate to any or more of market share, market standing, innovation parameters such as new product or service development, human resources, financial resources such as profit margins or expected revenue figures, physical resources such as manpower or other fixed assets, productivity measures, social responsibility, or profit requirements, among other such objectives.

One should appreciate that SBOs can be defined in terms of various “bottom line” metrics. One example bottom metric includes an economic bottom line, which can include profit, profit margin, impact on a local economy, impact on competitors, or other economic factors. More preferred SBOs are defined in terms of a “triple bottom line”, which is considered to include an economic bottom line, an environmental bottom line, and a social bottom line. Thus, the SBO could be graphically represented along three dimensions representing the triple bottom line. Most of the examples provided broadly fall along the first of these bottom lines, namely, the economic bottom line. Still, one should appreciate that SBOs can fall along the environmental and social bottom lines as well. Examples along the environmental bottom line could be reductions in greenhouse gas emissions from a certain activity (e.g., generating a kilowatt hour of power) or the average associated with a person traveling one mile to work. The social bottom line could include such factors as employment, improved skills later, better access to healthcare, garnered good will in a community, a change in education of a region, or other social impacts.

Program level strategic business objectives, on the other hand, can relate to objectives or high-level tasks that are expected to be achieved for anticipated or desired success of the program. As programs typically involve numerous projects having cross-project dependencies and can span over decades, SBO's for the programs can be high-level program oriented parameters such as risk parameters, time to completion parameters, costing parameters, designing parameters, environmental improvement parameters and societal improvement parameters which can, when complied with, help complete the program in a desired manner. Furthermore, as programs involve long term activities and impact the organization in a wider way, they typically support higher level vision, goals, or objectives of the organization and therefore, in the present disclosure, SBO's are interchangeably used for referring to program level SBO's or organization level SBO's and can encompass all possible objectives that can be defined or designed in an organization at any level of depth or breadth including short term projects or deliverables.

The program management system 100, also interchangeably referred to SBO tracking system 100 hereinafter, comprises a SBO database 110, an SBO analysis engine 120 operatively coupled to the SBO database 110, and an output device 130. The SBO database 110, the SBO analysis engine 120, and the output device 130 can be operatively connected to each other by a network 115. Network 115 can either be a wired or a wireless network and can comprise a WAN, LAN, VPN, the Internet, cellular telephone network, or other types of network.

SBO database 110 can be configured to store SBO objects 112 and SBO attributes 114, among other information pertaining to program management such as manpower attributes, costing attributes, performance attributes, time based attributes, among other such information. As discussed above, although the following discussion primarily discusses SBOs with respect to an economic bottom line, it should be appreciate that SBOs can be defined as a function of any of the triple bottom lines individually, collectively, or in any combination. Each SBO object 112 can relate to one or more SBO's and can store the objectives defined by the owner or other stakeholders in a quantifiable or qualitative manner. SBO's, as defined above, can be medium to long term objectives such as return on investment, number of offices, number of employees, percentage of revenue spent on corporate social responsibility (CSR) related activities, among other such high level objectives. SBO's can also be defined based on the technology domain to which the organization pertains or the product verticals that the organization belongs to. For instance, a pharmaceutical company can have SBO's relating to the number of drugs to be launched in the next 5 years or the geographies to be covered, or can even relate to number of patents being filed or granted. Furthermore, objectives such as % of revenues from patent licensing can be other high-level objectives that can be set by an organization.

Each SBO object 112 can relate to one or more objectives such that it collectively defines the objectives along with the relationship between the concerned objectives. For instance, an SBO object such as “Return on Investment” can relate to two objectives, namely percentage of profit margin and amount of investment. Similarly, multiple SBO objects 112 can be used to define a single objective, where an objective such as percentage of growth can be defined by objects including percentage of increase in revenues, percentage of increase in profit margin, percentage of increase in profit, percentage of increase in costs, among other such SBO objects 112. Multiple SBO objects 112 can also be designed at low-medium level so that they can individually be quantified or measured for their performance and cumulated when performance of the overall objective is being evaluated. For instance, for an organization having response time as a core objective to be consistently achieved, SBO objects such as “response time of six minutes or less”, and defined “response time to be achieved in 85% of the cases” can be defined. For simplicity of the present disclosure, we shall assume that each objective is defined by a single SBO object 112, which when monitored can yield information or give evaluation of the corresponding objective.

Each SBO object 112 can be defined by one or more SBO attributes 114. SBO attributes 114 can relate to parameters or indicators that can help measure or assess the SBO objects 112. For instance, for an SBO object 112 that relates to computation of return on investment, multiple attributes 114 such as number of projects, extent of investment in each project, amount of forthcoming expected investment, revenues or profit margins from each project, fixed cost associated with each project, among other such attributes can be incorporated and defined for the object 112.

In an embodiment, SBO attributes 114 can include key performance indicators (KPIs), which can be linked with SBO objects and help monitor execution of the business objectives. KPIs tend to be measurable, strategic, specific, repeatable, or significant enough to impact the program or organization level objectives. KPI can also include operational parameters, which when looked upon collectively can lead to indication of a strategic goal. For instance, for an SBO object 112 pertaining to employee retention objective, KPIs can include indicators such as number of active projects being run, percentage of workforce involved in active projects, frequency of off-work activities, frequency of employee feedback sessions, among other such indicators, which can also be attributes 114 of the concerned object 112.

SBO objects 112, and attributes 114 related thereto, can also be industry or technology specific. For instance, one SBO object 112 for a call-center organization can relate to increased customer satisfaction, wherein SBO attributes 114 for this object 112 can include % of queries resolved and resolution time of each query. As SBO attributes 114 can be measurable, thresholds can be defined for measuring or evaluating the SBO object 112 in view of the attributes. For instance, in the call center illustration, if the resolution time is 30 seconds or less, a higher weightage can be associated with the object 112 when compared to when the resolution time is 2 minutes or more.

SBO analysis engine 120 can be configured to include an SBO identifier module 122, a perception attributes identifier module 124, and a perception drift derivation module 126. The SBO identifier module 122 can be configured to identify one or more objectives to be assessed or monitored by the program management system 100. Based on the objectives to be monitored and evaluated, SBO objects 112 that correspond to the identified objectives can be retrieved along with their respective SBO attributes 114 such that a new subset of objectives, SBO objects, and corresponding SBO attributes can be retrieved and stored. SBO identifier module 122 can also be configured to identify stakeholders responsible for achieving or assessing the objectives. Such stakeholders can, not only include owners or key people internal to the organization but can include external stakeholders such as investors, bond holders, regulatory authorities, legislature, among other such entities that are directly or indirectly associated with meeting of the SBO objects, as well as those that may influence its achievement, either enhancing, degrading or blocking the achievement.

Each stakeholder involved in achieving a particular objective can be provided with a stakeholder interface so as to be able to monitor the SBO objects 112 associated with the objective and also view the SBO attributes 114 mapped to each SBO object. The interface can be displayed on an output device 130 such as a cell-phone, tablet, laptop, personal computer, or any other applicable computing device. The devices can be remote appliances that are configured to access the stakeholder interface for remotely giving inputs to the SBO analysis engine 120. Further, one or more stakeholders, based on their involvement or role in achieving the objective, can share a common interface. For instance, stakeholders that are part of a common project team can be allowed to share interfaces. Furthermore, SBO objects 112 and their corresponding SBO attributes 114 that are viewed can vary for different stakeholders. For instance, for a given objective, a management level stakeholder may be able to view a larger set of SBO objects 112 when compared with a stakeholder who is lower in the organizational hierarchy. Even the number of SBO attributes 114 that are viewable for a specific SBO object 112 can vary across stakeholders. Such a variation can be based on factors such as hierarchy of the stakeholder in the organization, location of the stakeholder, stakeholder's relevance to the specific objective; SBO object; or SBO attributes, characteristics of the specific objective; SBO object; or SBO attributes, among other such factors.

Objectives identified by the SBO identifier module 122 may or may not be directly related to each other. For instance, % of revenue spent on CSR activities can be identified as an SBO along with the return on investment so to help the key stakeholder view both the objectives together and give their perspective on the same. Furthermore, two or more objectives can also designed such that they share SBO objects and therefore common SBO objects may also exist across strategic business objectives. For instance, % of net profit margin may be an SBO object that is common to objectives such as return on investment and productivity of the organization.

The perception attributes identifier module 124 can be configured to receive perception attributes from the identified stakeholders in view of the SBO objects 112 and their corresponding SBO attributes 114. Perception attributes can reflect the perception of the concerned stakeholder about the identified objective by means of his/her views on the SBO attributes of one or more SBO objects to which the objective relates. Each stakeholder can, for instance, through the stakeholder's interface, view the SBO attributes viewable at his/her end and give his perception about each or a partial set of the SBO attributes. Such perception can be quantitative or qualitative and can also be received along with the reasons for that perception.

Average employee retention of 8 years can be a strategic business objective of an organization, which can be translated into an “employee retention” SBO object 112 and have attributes 114 such as salary structure, whistle blowing policy, job satisfaction, level of challenge in work profile, growth opportunity, feedback sharing mechanism, among other such attributes. The perception attributes identifier module 124 can be configured to, for the employee retention SBO object, obtain from one or more stakeholders their perception about the SBO attributes 114 and present the same in the form of SBO perception attributes. For instance, each stakeholder can rate each attribute according to their perception by ranking them on a scale of 1-10, where, for example, feedback sharing mechanism can be ranked as 8 and job satisfaction can be ranked as 6.

Each perception attribute of an SBO object 112 can be assigned a pre-defined weight based on its significance to the SBO object. The weighted SBO perception attributes can then be combined in accordance to their respective weight to yield a final perception value for the SBO object 112. For instance, for employee retention as the SBO object 112, salary structure can be assigned a higher weight of 0.7 when compared with the whistle blowing policy, which can have a lower weight of 0.3. Therefore, when each perception attribute corresponding to SBO attributes 114 is received, they can be cumulated with respect to their respective weights to give a final perception of the stakeholders for the SBO object 112. It should be appreciated that these weights can be changed based on the stakeholder involved, SBO object in context, objective being measured, SBO attributes in picture, among other such factors.

SBO perception attributes can be received from the stakeholders through a survey that can be presented to each stakeholder via their respective interface. The survey can indicate SBO objects 112 that applicable to the respective stakeholder and further indicate SBO attributes 114 relating to the SBO objects 112 that are enabled for viewing by the respective stakeholder. As mentioned above, apart from general and common SBO objects, specific technology or industry vertical based SBO objects can also be defined along with their respective specific SBO attributes. For instance, for construction industry, SBO objects can relate to long term construction projects such as setting up of information technology parks, acquisition of land, strategy of handling tender procedures for Government programs, pipeline based programs, among other such objectives.

In one embodiment, SBO perception attributes can be derived based on project phases. As discussed above, each program can include numerous small to medium term projects and therefore instead of periodic intervals, the SBO perception attributes can be derived after the completion of every project so as to assess the deviation in perception of the overall objectives in view of the stakeholders. Such assessment can reflect the impact of the concerned project on the perception of the stakeholders about the SBO and can help evaluate the key aspects of the project that were strategic in nature in view of the SBO. In an embodiment, each SBO perception attribute can be normalized to a namespace that is used to represent the corresponding SBO attribute 114. Normalization of the namespace can allow harmonization in the nomenclatures and efficient mapping of the attributes 114 with the perception attributes.

Once the SBO perception attributes have been received from one or more stakeholders, they can be stored in the SBO database 110. SBO perception attributes can be measured for each stakeholder periodically so as to assess the change in perception of the stakeholder about the concerned objective. In such a case, the SBO database 110 can be periodically updated with the perception attributes that are received from the same stakeholder after periodic intervals. Such perception attributes can either be stored for each periodic interval or can be overwritten so that the most updated perception can be presented at any point in time.

The perception drift derivation module 126 can be configured to derive an SBO perception drift of the SBO object as a function of the stakeholder's SBO perception attributes and the SBO attributes of the SBO object. SBO perception drift can indicate the difference and the magnitude of such difference between the owner's perception towards the objective and the actual perception of the stakeholders. Larger the perception drift, higher is the difference in perception and more severe can be the consequences if the perception attributes of various stakeholders remain the same for a consistent period of time. Considering the employee retention SBO object, in case the overall perception attributes, when taken into consideration with the SBO attributes, indicates that the employee retention is actually only amounting to 3 years when compared with the desired objective of 8 years, the perception drift of 5 units can be computed on a relative scale. During computation, deviation or magnitude of difference can initially be computed between each SBO perception attribute and corresponding SBO attribute of the SBO object and then the deviation for all SBO attributes can be cumulated to compute the SBO perception drift of the SBO object.

In an embodiment, the perception deviation module 126 can be configured to derive perception drift for each stakeholder such that each individual drift can be assessed or analyzed for comprehending the reasons behind the drift. Monitoring the drift for each stakeholder can also help assess the individual perception attributes of the concerned stakeholder and mapping the key areas due to which the drift has occurred. In another embodiment, the perception deviation module 126 can be configured to derive a cumulative perception drift for the SBO object such that the overall perceptions of all concerned stakeholders can be combined through a defined mathematical expression to generate a comprehensive and more reliable drift. As each stakeholder can have different weights associated with their inputs and perception attributes based on their depth in the organizational hierarchy, role in the organization, involvement in the concerned SBO object, experience in the organization, among other factors, cumulative perception drift for the SBO object can be computed in accordance with the weights. Yet another aspect of perception drift can be measured on a relative basis. For example, each stakeholder's perception drift can be compared to other perceptions to derive a relative perception drift. Such an approach is considered advantageous to determine if one set of stakeholders are gradually aligning their views and perceptions with a second group of stakeholders, or if the perceptions of the two groups are becoming more divergent which could potentially impact achievement of the owner's SBOs.

It should be appreciated that a larger perception drift might not always indicate a negative effect on the organization. For instance, perception drift can be positive and much higher than the objective that the SBO object represents. Considering the same example of employee retention as the SBO object, in case the perception drift indicates the employee retention to be 10 years, the drift of 2 relative units from the objective of 8 years can indicate a strong positive perception drift of the concerned stakeholders. In another instance, even though a negative perception drift can indicate deviation from the defined strategic business objectives, assessment of the drift and of the reasons behind the same by evaluation of the SBO perception attributes can indicate that the defined objective itself needs to change or be amended with time. As business processes, organization structures, global economic standards, growth pattern, among other such parameters keep changing and evolving over time, long term objectives often need to be revisited and amended to ensure continuity of the business and compliance with the overall vision of the organization. For instance, with maturity of an organization, it might become important for the organization to revisit its CSR policies and redefine them to ensure compliance with industry standards. Such redefined policies can be indicated through the SBO perception drift or assessment thereof and accordingly the objectives can be amended.

As SBO perception attributes received from one or more stakeholders can vary with time, SBO perception drift computed by the perception drift deviation module 126 can also vary with time and can be an indicator of the change in drift patterns over defined time intervals. For instance, SBO perception drift can be computed every 6 months and based on each computation, the organization can take desired measures to reduce the drift. Based on the measures taken, when the perception drift is computed again after the next 6 month interval, the magnitude of drift can help understand the effect of the measures so that further actions can be taken to improve the drift to the desired level.

SBO perception drift can be obtained using the perception drift deviation module 126 as a multi-valued object such that a single drift can represent the change in perception for two or more SBO objects, which may or may not be directly related to each other. For instance, a single perception drift may be able to represent SBO objects for % of growth and % of profit margin to make an assessment relating to perception of stakeholders about relationship between profit margin and growth, profitability of company, potential for growth, among other characteristics relating to these objectives. Using multi-valued SBO perception drift can enable the stakeholders to view multiple SBO's on the interface at a single time and respond to the survey keeping the objectives in mind, which also helps perception drift assessment team to view the complete picture and overall achievement of the objectives. In another embodiment, SBO perception drift can include N-tuple of data members, wherein each data member can represent perception attributes, timestamp, reasons for the input perception attributes, and characteristics of the concerned stakeholder, among other such attributes.

An output device 130 can be configured to present SBO perception drift along with SBO objects 112 and SBO attributes 114 to which the drift pertains. SBO perception drift metric 135 illustrates an exemplary representation in the form of percentage change in perception drift from the previous drift measurement. As illustrated in metric 135, representation on the device 130 can include the list of SBO objects under consideration, SBO attributes considered to be relevant for the concerned stakeholder, and the values of the SBO perception attributes that are corresponding to the SBO attributes. The metric 135 can further be configured to present the periodicity interval after which the drift is intended to be computed and finally present the percentage change in drift measurement from the previous measurement. For instance, for employee retention SBO object, the attributes including feedback policy, salary structure, or appraisal policy can be listed in the second column. In response to one or more SBO attributes, SBO perception attributes can be entered by the concerned stakeholder, wherein the perception attributes can be represented as numeric values or qualitative description. Such perception attributes can be asked from the stakeholders based on the periodicity interval mentioned in the metric 135, which could range from days to months to years. Once all the perception attribute values have been entered by the stakeholder, they can be cumulated to compute the extent of perception drift from the desired perception of the SBO object, indicating the actual perception of the concerned stakeholder.

It should be appreciated that the metric 135 is only an exemplary representation and many other factors or parameters such as identification information of stakeholder, stakeholder's details, weights of each attribute, among other such factors can be incorporated in the metric 135 to make it more comprehensive. Furthermore, metric 135 can either be created for each stakeholder or can be a combined representation of perception attributes received from multiple stakeholders. Metric 135 can also be represented in a multi-dimensional format with stakeholders and their characteristics being the first dimension, SBO objects and perception attributes being the second dimension, and periodicity being the third dimension. Metric 135 can further include feedback comments of the stakeholders with respect to the SBO attributes and can help the responsible management to understand the rationale behind the change in perception of the concerned stakeholder and take the necessary measure.

Metric 135 can further be configured to present all previous SBO perception attributes of stakeholders so as to help assess the change in perception over the previous surveys and help compare the attributes in which major changes or drifts have occurred. The output device 130 can also be configured to automatically process the current SBO perception drift and present the processed outcome including weightage-based prioritized list of perception attributes that led to the maximum drift and therefore made the maximum impact in achievement of the desired objective. The output device 130 can also be configured to present whether the drift positively or negatively impacts the organization and concerned SBO's. The output device 130 can be a web browser, a cell phone, a tablet, a printer, a computer device or other type of suitable device.

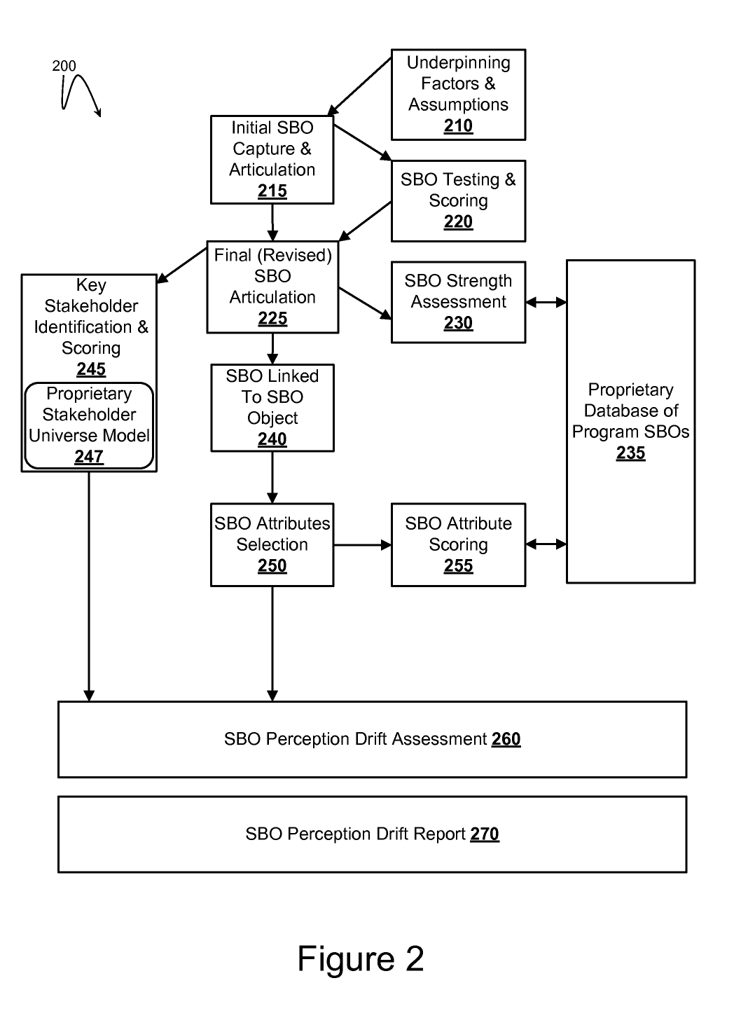

FIG. 2 is a schematic block diagram 200 of a program management system. Representation 200 shows multiple steps involved in tracking strategic business objectives (SBO) in terms of perception of one or more stakeholders about the SBO's. The system can start by underpinning the factors and assumptions relating to the SBOs intended to be achieved by an organization or by a program being run in the organization. Such assumptions can be defined at block 210 and can relate to political, economical, geographical, or other such factors that, if changed, can significantly impact the organization's sustainability and therefore need to be assumed for defining the SBO's and achieving them in the desired manner. The assumptions can either be very high level assumptions relating to potential emergencies or natural calamities or can be relatively low levels assumptions relating to potential development of a new ecosystem near the organization's location such as building of IT parks or residential buildings.

Once the assumptions and factors affecting objectives have been laid out, SBO's can be captured and articulated in block 215. In this block, the high level objectives can be drafted or captured by certain key stakeholders including the owner or the key person responsible for executing the objective and the captured objectives can then be made to review by one or more independent stakeholders such that the objectives can be further refined, amended, or cancelled to finally yield a defined, measurable, clear, and concise set of objectives. The process of articulation can be done repetitively or intermittently with an aim of reconfirming the thought process of the key stakeholders. As discussed above, the SBO's can either be organization wide objectives such level of productivity, rate of growth, or can be program wide objectives such as number of resources, time to completion, among other such objectives. It should also be appreciated even though the organization or program wide objectives are being discussed in the present disclosure, the instant invention can clearly be applied to medium to short term projects as well and enable assessment of the level of drift in perception of key stakeholders or people responsible for running or handling the projects.

At block 220, once the SBOs have been captured and articulated by multiple stakeholder groups, the SBOs can be tested and scored. In this step, each identified SBO can be tested, either manually or through an algorithm, on the potential impacts it can have on the organization in the short or medium term. SBO testing and scoring can also assess the potential negative impact that the objectives may cause in course of their achievement. For instance, in case an objective relating to maintaining average employee retention to 8 years is defined, a strong pressure might get created on HR department of an organization to try and achieve the objective, which might create undesired impact on the HR and other allied parts of the organization and may, in fact, create a counter affect. Each SBO can therefore be validated, not only by the stakeholders, but also by neutral people outside the organization or people directly involved in implementation of the objective, which can help ensure that the SBO has been evaluated or scored by multiple types of audience to give it more credibility.

At block 225, once all the captured SBOs have been tested and scored, they can again be articulated for further refinement. Such refinement can range from small amendments to the objectives to make them more specific or measurable or can include major amendments such as changing the entire scope of the objective and how the same would be assessed, measured, or evaluated based on multiple SBO attributes.

At block 230, strength of each finalized SBO can be assessed. Strength of each SBO can be computed based on multiple characteristics such as relevancy of the SBO to the organization, time within which the SBO is expected to be achieved, number of departments, environmental impact of the SBO, geographic weighting, potential concerns that the SBO may lead to, number of SBO objects and attributes that would need to be defined for covering the objective, level of measurability of the objective, level of dependency on other objectives, number of stakeholders involved in the objective achievement process, among other such characteristics. The strength can be depicted on a point scale such as on a 10 point scale and can be stored in SBO database along with the SBO objects, SBO attributes, or SBO perception attributes.

Block 235 can be used to help assess the strength of the captured or finalized SBO. Block 235 can include a proprietary database of program SBO's that can be used for measuring the strength of the SBO. The proprietary database of program SBO's can be modified with time so that the strength or weights associated with the objective in context can be assigned based on current business environment. For instance, the importance of CSR in an organization is much more right now when compared to what it was ten years back and therefore the strength of a CSR related objective would be more when compared to the earlier period of time.

Furthermore, once the SBOs are finalized along with the parameters that would be used to periodically measure their achievement, at block 240, each SBO can be linked to one or more SBO objects that define the objective. As discussed above, each SBO object can also be used for defining or representing one or more related or distinct objectives. For instance, number of projects in a program can be used as an SBO object for evaluating the objective of productivity as well as return on investment. SBO objects can further either be selected from a list of known SBO objects or can be created so as to represent the SBO in a defined manner. For simplicity of the present disclosure, each SBO has been linked to one SBO object that is representative of the objective intended to be achieved.

At block 245, one or more stakeholders are identified for each objective identified in block 225. As stakeholders can be internal or external to the organization and can vary based on their hierarchy, role, breath in the organization, experience, among other parameters, each stakeholder can be associated with a score that identifies their responsibility in achieving the objective and hence their importance in the program. For instance, each parameter based on which stakeholders can be measured can first be identified and then associated with weights such that the overall score is given from 100. Once all the parameters under consideration are known, each stakeholder can be fitted onto the parameters and a score can be computed for the concerned stakeholder. For instance, a Sr. Manager with 7 years of experience with the organization as a project manager could have 65 points vis-a-via an Assistant Manager with 4 years of experience in the organization. The senior most local government official would likely carry a higher score than a public records clerk. Association of scores with each stakeholder can help the proposed system understand the importance of the perception of the concerned stakeholder and help compute the perception drift of the SBO objects associated with the objective accordingly. In other words, during the process of combining perceptions of each stakeholder for a particular objective, higher importance can be assigned to perceptions of stakeholders having higher scores.

At block 247, for an organization, a proprietary stakeholder universe model can be created such that the model encompasses lists of all stakeholders in the organization for any given objective and details or relationships between such stakeholders, if any. The model can therefore initially include a list of all the employees, management, and external people directly or indirectly associated with the organization, and then select one or more sets of stakeholders that would be responsible for achieving one or more defined SBOs. External stakeholders (e.g., contractors, sub-contractors, vendors, suppliers, consultants, advisories, etc.) can have significant impact on an SBO, but might be only indirectly influenced. Stakeholders can then be linked to each other based on their role or responsibility in the organization or based on their designation, experience, level of involvement in fulfilling the SBOs, among other such attributes. Through such linkages, issues with external stakeholder, or internal stakeholders for that matter, can be identified quickly. Further, the links can provide an insight into a channel through which a program manager can properly assert influence on the external stakeholder in order to bring the external stakeholder into properly perception alignment.

At block 250, for each identified SBO object that relates to one or more SBOs, SBO attributes defining the SBO object can be selected. SBO attributes can relate to multiple factors that can help describe aspects about the concerned SBO object, and which when put together can help gain a comprehensive opinion or make an analysis of the SBO object, its extent of success, reasons for achievement, problem areas, among other characteristics of the SBO object. SBO attributes of the present disclosure can be identified and configured such that they can be opined on by one or more stakeholders identified in the block 245. Such an opinion may not only include an objective measure of the SBO attributes but also qualitative assessment of the attributes including concerns behind the attribute, reasons behind such concerns, among other such qualitative attributes.

In an embodiment, SBO attributes can include key performance indicators (KPIs) that can directly or indirectly relate to SBOs and help objectively measure the degree to which the SBOs have been achieved. Multiple KPI's that are linked to one or more SBO objects can be configured to focus on a specific aspect of the objective and consistently measure the change in pattern of the objective over a period of time and then help form or compare the trend of change to the desired behavior. As each SBO has been linked to one or more stakeholders who are directly or indirectly responsible for achieving the concerned objective, the stakeholders can also be assigned one or more of the KPIs so that they are not only evaluated based on the KPIs but can also comment or give their perception on the manner in which or extent to which the KPIs have been able to achieve the objective and reasons behind the same. Of particular note, the KPIs of external stakeholders, especially program adversaries, could measure the stakeholder's negative contributions rather than positive contributions to SBO achievement.

In an exemplary illustration, assuming an online retail organization sets an SBO stating that the order must be processed within three days compared to the current average of five days. Such an objective can automatically relate to an “order completion” SBO object and can be represented by multiple SBO attributes, which can include one or more KPI's. One such KPI can relate to “shipment duration” and state “For the Delivery process, track the order date against the delivery date and monitor when the average time to shipment is within a 20% range of the five days target”. Such a KPI can not only encompass assessment of the average time to shipment over a defined period of time but can also help concerned stakeholders such as purchase management, stock holding team, among others to be able to give their perception of the actual time to shipment, bottleneck areas, people responsible for such bottlenecks, among others.

Block 255 can be configured to screen or process each identified SBO attribute relating to an SBO object so as to assign certain weight or a significance factor to the attribute. Such evaluation of the attribute can take place using the SBO database of block 235, which not only includes the SBOs but also specific factors that help achieve or measure the objectives. Once each SBO attribute is measured and associated with the corresponding significance factor, the attributes can be combined based on the significance factors during periodic assessments of the SBO objects and further based on the perception of the weighted attributes by the identified stakeholders.

At block 260, for each SBO attribute constructed or measured in blocks 250 and 255, identified stakeholders from block 245 can give their SBO perception attribute through a survey or other known mechanisms such that a list of SBO perception attributes is generated for each SBO object to which the SBO attributes relate. Based on the SBO perception attributes received from the concerned stakeholders and SBO attributes to which the concerned SBO object pertains, a SBO perception drift can be derived for the SBO object, which drift relates to the difference in perception of the stakeholders about the objective to which the SBO object relates from the desired perception of the owner. The perception drift can either be computed for each stakeholder or can be combined for each stakeholder to represent a consolidated perception drift for the SBO object.

As discussed above, each stakeholder, based on his/her designation, role, responsibility, among other such organizational parameters, can be responsible for or potentially influence or impact one or more objectives. As each stakeholder can be assigned scores based on such organizational parameters, SBO objects linked to each stakeholder can be different, and even within each SBO object, SBO attributes on which the stakeholders give their perception can be different. For instance, a stakeholder at a project level may be able to give his/her perception on lower level SBO attributes when compared with a stakeholder at a program level. Such stakeholder based allocation of objectives, SBO objects, or SBO attributes can help compute an accurate or more realistic perception drift, which can then be evaluated by key people responsible for measuring the achievement of objectives or help them implement strategies to reduce the perception drift for organization-wide aligned approach towards SBOs.

At block 270, the computed perception drift of each SBO object can be reported or presented on an output device for assessment by people responsible for achievement of the SBOs. Perception drift can be presented in multiple visual or textual formats such that the perception drifts are not only viewed in silos but also together with drift of other SBO objects. The output device can also be configured to present key reasons behind the drift, possible suggestions to change the objective or incorporate policies that can help reduce the drift or make the stakeholders align to the common SBO. The output device can also be configured to represent multiple statistics including the stakeholders involved in maximum perception drift, which can help understand the group of people who are most misaligned. The device can also present the change in perception drift from the last time it was measured, effect of change in policies after the last time, SBO attributes that caused maximum perception drift, among other like characteristics of the SBO attributes and perception drift.

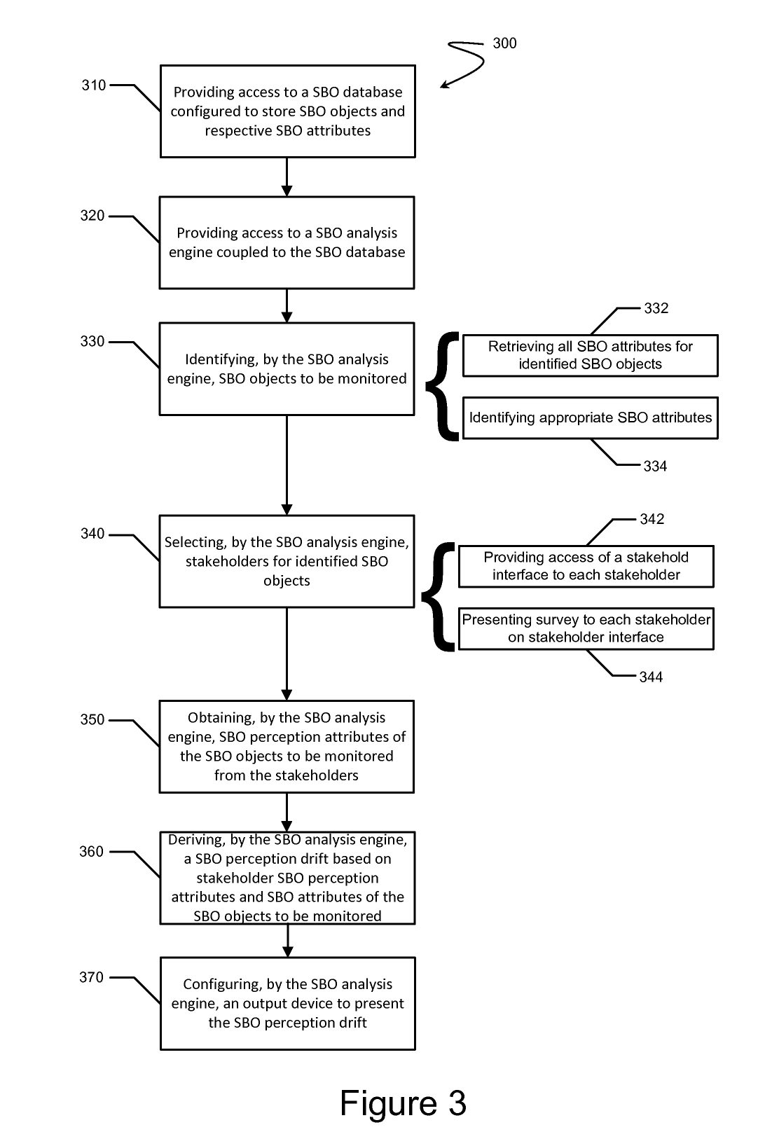

FIG. 3 presents a method 300 for program management and allows tracking of strategic business objectives (SBOs) such that perception of stakeholders involved in achieving the objectives is considered to assess the level of drift in perception with respect to the intended perception and take desirable measures to mitigate the drift and reduce the risk to which the organization is exposed by increase in the drift.

Step 310 can allow providing access to a SBO database that stores SBO objects and respective SBO attributes. SBO objects can relate to one or more SBOs and can be configured to act as a measurable entity responsible for evaluating the level to which the objectives have been achieved. SBO attributes relate to factors that can be used to assess or evaluate the SBO object, and which when combined together can give a clear representation of the SBO object. The SBO database can also be configured to store other relevant content such as stakeholder information, definition or other characteristics of the objectives, SBO perception attributes, perception drift values among other such information.

Step 320 can include providing access to an SBO analysis engine that is operatively coupled with the SBO database. The SBO analysis engine can be configured to measure the alignment of stakeholders with the defined SBO's by taking into consideration the perception of the stakeholders for the SBO objects that are applicable to the concerned objectives. The analysis engine can either be implemented within the same computing device that stores the SBO database or can be implemented at a remote device. The engine can be configured to present a survey having multiple SBO attributes to the stakeholders and take the perception of the stakeholders about the SBO attributes as input to finally process inputs from the stakeholders to achieve a perception drift of the SBO object to which the SBO attributes pertain.

Step 330 can include identifying, from all SBO objects stored in the SBO database, a list of SBO objects that need to be monitored. As each SBO object can relate to an independent objective; based on the objective that needs to be measured, SBO objects relating to the objective can be retrieved from the SBO database. For each identified SBO object, SBO attributes corresponding to the SBO object can also be retrieved.

Step 332 can include retrieving all SBO attributes that relate to the identified SBO objects, where the SBO attributes define or help measure the SBO objects or help assess the level to which the objectives that the SBO objects relate to, have been achieved. SBO attributes can also be stored in the SBO database and can be associated with desired behavior or values, which when obtained would help achieve the SBO. For instance, for an SBO object relating to “increasing the number of interactions people have on the site”, an SBO attribute can include “rate of new comments being posted”. Similarly, for an SBO object relating to “increasing the percentage of returning visitors”, an SBO attribute can include “percentage and frequency of returning visitors or re-logins”.

Step 334 can include identifying appropriate SBO attributes that are relevant to the SBO or the corresponding SBO object in context of the industry, product vertical, technology domain, stakeholders involved, among other attributes. As SBO attributes stored in SBO database can include all possible attributes that relate to the respective SBO object, all the SBO attributes might not be relevant in the given context or the purpose for which the perception drift is intended to be computed. Therefore, a subset from the list of SBO attributes can be selected based on their relevancy to the context or purpose of the SBO such that the identified SBO attributes, when perceived by the stakeholders, give a clear impression of the change in perception of the concerned SBO object.

Step 340 includes selecting one or more stakeholders that are responsible for achieving the identified SBO objects. Such stakeholders can either be within the organization and include management, owners, directors, program managers, among other people, or can be outside the organization and include bankers, financial institutions, consultants, vendors, regulators, local community groups, and relevant NGOs (non-governmental organizations) among other entities. As each stakeholder has a distinct responsibility or relationship towards achieving the defined objectives; importance of their perception varies based on their role, experience, designation, among other factors. Furthermore, even the allocation of SBO objects or attributes thereof to stakeholders can vary based on the abovementioned factors.

Step 342 includes providing access of a stakeholder interface to the selected stakeholders. Stakeholder interface can include a user interface on which the stakeholder can attend to a survey that is intended to track the SBOs by asking several qualitative or quantitative questions about the SBO attributes of the SBO object that needs to be tracked. The stakeholder interface can also be configured to remotely receive inputs from multiple stakeholders, which may or may not allow viewing of the inputs from other stakeholders. Example stakeholder interface can include cell phone, tablets, applications, or browser based computer system. Especially interesting stakeholder interfaces can include social networks or social media interfaces (e.g., Facebook interface, Sharepoint, Google Docs, Survey Monkey, etc.). Stakeholder interface can also be configured to present the finally computed SBO perception drift and help the stakeholders assess the difference between their respective perception of the objective and the desired perception.

Step 344 includes presenting the survey to the selected stakeholders on the stakeholder's interface. The survey can include a series of questions aimed to assess the perception of stakeholders about the SBO objects based on their views of the SBO attributes that each SBO object relates to. The survey can be configured to present questions which can be answered on a scale of say 1-10, and therefore help make the assessment of the attributes objective. Inputs given to the survey by the stakeholders can be referred to as SBO perception attributes.

Step 350 can include executing the SBO analysis engine to obtain SBO perception attributes from one or more stakeholders for each concerned SBO object. SBO perception attributes can correspond to SBO attributes of each SBO object and can be expected to present the perception of the stakeholders about the SBO attribute. For instance, for “employee retention” SBO object, SBO attributes can includes feedback policy, satisfaction from current compensation structure, and satisfaction with job description, among other attributes. Based on these SBO attributes, each stakeholder can be configured to give his perception, qualitatively or quantitatively, about the attribute, about the level to which the overall SBO object has been achieved, about the relevance of the attribute to the SBO object apart from other such views, as SBO perception attributes.

Step 360 can include deriving a perception drift for each SBO object based on the SBO perception attributes and the SBO attributes. In an embodiment, as each SBO attribute can be quantified before measurement of the SBO perception attributes, once the perception attributes have been computed, the drift can initially be computed for each attribute and then an overall drift can be computed for the SBO object. Such difference between SBO perception attributes and SBO attributes can either be computed by simple subtraction of the attribute values or can be computed by a software based on qualitative and quantitative assessments. Furthermore, as SBO perception attributes can be obtained based on a survey, the SBO analysis engine can automatically take the inputs from the survey into a software and analyze the perception attributes at run-time with the SBO attributes to compute an attribute-level drift and then combining the drifts to achieve a perception drift for the SBO object. Beyond surveys, perception attributes can be obtained through other techniques. In some embodiments, communications (e.g., emails, text messages, reports, etc.) can be analyzed to determine stakeholder opinions or sentiments with respect to SBO topics. Such opinions or sentiments can then be mapped to perception attributes. Additional techniques can include attendance of stakeholders with respect to one or more meetings or events where attendance can be considered, at least as some level, alignment with SBO while lack of attendance could indicate lack of alignment. For example, if an SBO is defined in terms of a social bottom line with respect to a city or other region, then it might be expected that stakeholders would attend public hearings or events related to the SBO. If the stakeholders do not attend the public hearings or events, then the perception of the stakeholder might be drifting away from the SBO.

Step 370 can include presenting the SBO perception drift for each SBO object on an output device. The output device can, along with the perception drift, present other information such as SBO attributes having maximum drift, key stakeholders having the widest perception drift, key concern areas, potential suggestions to mitigate the risks caused by the increase in perception drift, the percentage change in perception drift from the last time it was measured, frequency of measurement of perception drift.

It should be appreciated that even though the present disclosure has been described with reference to high-level SBOs that are defined for programs or organizations at large, the systems and methods of the present disclosure can be applied to small and medium term projects as well. For instance, for a one year software product development project involving creation of ten features, perception drift of the members of the project can be measured after completion of each feature for SBO attributes including resource allocation, timely delivery, acceptable level of bugs, among other such attributes that can be defined for successful project execution as an SBO object.

The above disclosed techniques describe monitoring drift in perceptions of SBOs for one or more programs. It is also contemplated that the disclosed systems can include one or more historical databases configured to store past programs and their associated SBO perceptions. Such information can be folded into development of perception attributes through various methods. In some embodiments, a current SBO can be compared against a historically similar SBO. As the current perception attributes are measured, the attributes can be weighted according to how the historically similar SBO changed or its perceptions changed with time. Further, historically similar SBOs and their perceptions drifts can be used as a predictor of how perceptions in the current SBO might drift. Such an approach is advantageous because it allows a program manager to anticipate possible shifts in perception and take corrective actions if necessary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are also used euphemistically to mean “communicatively coupled with” in the sense that two networked devices are able to communicate with each other over a network, possibly through one or more intermediary devices.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of tracking capital construction program strategic business objectives (SBO), the method comprising:
providing access to a SBO database storing SBO objects representative of objectives spanning across construction projects within a capital construction program, the SBO objects having SBO attributes;
providing access to an SBO analysis engine coupled with the SBO database;
obtaining, by the SBO analysis engine, from at least one stakeholder a plurality of stakeholder SBO perception attributes regarding a program objective;
deriving, by the SBO analysis engine, an SBO perception drift of at least one SBO object as a function of the stakeholder SBO perception attributes and SBO attributes of the at least one SBO object;
configuring, by the SBO analysis engine, an output device to present the SBO perception drift.

2. The method of claim 1, further comprising providing access to a stakeholder interface to a plurality of stakeholders and obtaining the stakeholder SBO perception attributes via the stakeholder interface

3. The method of claim 2, further comprising configuring the stakeholder interface to present a survey derived from SBO attributes of SBO objects associated with the construction program.

4. The method of claim 2, further comprising configuring the stakeholder interface to obtain stakeholder perception attributes from remote devices.

5. The method of claim 2, wherein the step of configuring the output device further include presenting the SBO perception drift on the stakeholder interface.

6. The method of claim 1, wherein the step of deriving the SBO perception drift includes deriving the SBO perception drift as a multi-valued object.

7. The method of claim 6, wherein the SBO perception drift comprises an N-tuple of data members.

8. The method of claim 6, wherein the SBO perception drift varies with time.

9. The method of claim 6, wherein the SBO perception drift varies with a hierarchy of stakeholders.

10. The method of claim 9, wherein the SBO perception drift varies with to a depth within the hierarchy.

11. The method of claim 9, wherein the SBO perception drift varies with a breadth across a level within the hierarchy.

12. The method of claim 6, wherein the SBO varies with geography of the stakeholders.

13. The method of claim 1, wherein the step of obtaining from the at least one stakeholder the plurality of stakeholder SBO perception attributes occurs periodically;

14. The method of claim 13, further comprising obtaining the SBO perception attributes according to project phases.

15. The method of claim 13, further comprising obtaining the SBO perception attributes in real-time.

16. The method of claim 1, further comprising generating a drift alignment recommendation on re-aligning SBO perception drift as a function of the SBO attributes and the SBO perception attributes.

17. The method of claim 1, further comprising presenting, by the SBO analysis engine, the drift alignment recommendation on the output device.

18. The method of claim 1, further comprising normalizing the SBO perception attributes to a namespace used to represent the SBO attributes.
